(19) United States
(12) Patent Application Publication
(10) Pub. No.: US 2013/0206173 A1
(43) Pub. Date: Aug. 15, 2013

(54) MOBILE CLEANING DEVICE FOR SOLAR PANELS

(71) Applicant: Jelle Zijlstra, Zaventem (BE)

(72) Inventor: Jelle Zijlstra, Zaventem (BE)

(21) Appl. No.: 13/817,137

(22) PCT Filed: Aug. 23, 2011
(86) PCT No.: PCT/EP2011/064472

§ 371 Date: Apr. 26, 2013

(30) Foreign Application Priority Data
Aug. 24, 2010 (EP) 10173870.6

(51) Int. Cl. B08B 1/00; B08B 3/02

(52) U.S. Cl. CPC B08B 1/00; B08B 3/024
USPC 134/6; 15/246; 134/34

(57) ABSTRACT

The invention concerns a mobile cleaning device suitable for displacing along and cleaning a series of adjacent tilted solar panels aligned in a row and requiring therefor no superstructure fixed to the row of solar panels. The device includes a supporting frame defining a cleaning plane, on which are mounted a cleaning device suitable for cleaning a surface parallel to the cleaning plane, a support device for maintaining the supporting frame substantially parallel to the surface to be cleaned during the displacement of the cleaning device along a row of solar panels; and a guiding device for guiding the displacement of the cleaning device along a row of solar panels. The guiding device includes at least two, preferably at least three, separate guiding wheels, which are aligned along a straight line parallel to the cleaning plane and adjacent to a first edge of the frame. Each guiding wheel is mounted such as to rotate about an axis substantially normal to the cleaning plane and suitable for resting and rolling on the upper edge of the aligned solar panels with the cleaning device in cleaning contact with the surface to be cleaned.

### TECHNICAL FIELD

The present invention relates to a device for cleaning solar panels. In particular, it concerns a motorized device for cleaning a series of aligned solar panels forming rows, which are tilted with respect to the horizontal and requiring no particular superstructure for its guiding along a row.

### BACKGROUND FOR THE INVENTION

Most States have committed to use green energy to satisfy a given fraction of their total power consumption, in order to reduce the emission of greenhouse gases. For this reason, the number of solar panels has increased substantially in the last years, even in Northern European countries not particularly known for being sunny. These panels can be found on the roofs of individual houses with an exposed area of a few square metres, as well as on larger solar panels farms exposing surface areas of dimensions which can vary substantially, from the covering of the roof of a building or a large warehouse with a few rows of solar panels, to entire fields covered with rows and rows of solar panels. In order to optimize the exposure of the solar cells to solar radiations, the solar panels are usually exposed with an angle with respect to the horizontal. In individual houses, the roof is already sloped and the solar panels are usually mounted parallel to the slope of the roof. In solar panels farms, on the other hand, the solar panels usually rest on a substantially horizontal surface and are arranged in a series of usually parallel rows where the panels are arranged side by side, with an angle with respect to the horizontal and separated from the rows in front and on the back by a distance sufficient to prevent the projected shadow of the panels of the front row to be cast onto the panels of the adjacent back row at the peak hours of sun radiation. The tilting angle may vary from about 5 to 10 degrees to up to 45 degrees. Tilting angles of between 30 and 40 degrees are usually considered as optimal, in particular in Northern Europe countries.

In all cases the solar panels must be cleaned in order to not decrease the intensity of the solar radiation reaching the solar cells. If a few square meters of panels covering the roof of a private house may be cleaned manually, this is not practical when the area of solar panels increases substantially. Automatic cleaning devices for cleaning a series of solar panels aligned in rows have been proposed in the art.

Automated cleaning systems for cleaning solar panels are described in US2010/0043851 and in http://www.gizmag.com/heliotex-solar-panel-cleaning/11009/, wherein spraying nozzles are disposed at different places in a row or an array of solar panels. This cleaning systems do not comprise any means for wiping, brushing, or scrubbing hard adhering dust and dirt off the surface of the panels, and the cleaning of the panels is therefore not optimal.

Cleaning robots are sometimes used for cleaning solar panels. Their mobility is often rather slow and the passage from one panel to another is possible only when the alignment between the two panels is very good. These robots are therefore limited, at least to date, to the cleaning of rather small areas of solar panels. Examples of such robots can be found e.g., in http://www.youtube.com/watch?v=HZjpNTksdqA showing a so called gecko, or in http://www.youtube.com/watch?v=OjFbQ63Aryg. Many other examples of such cleaning robots can be found on internet.

Several solutions for cleaning rows of solar panels comprise a moving cleaning device suitable for moving along the direction of the row and guided by two rails situated on top and at the bottom of the solar panels and running all along the length of the row of solar panels. In some cases, the cleaning device can move along a rail normal to the two guiding rails, to clean the whole surface of the panels, or the cleaning device spans over the whole height of the solar panel and moves only in one direction parallel to the guiding rails. Examples of such systems can be found e.g., in JP2002/273351, KR2009/0058624, CN201111305, KR2009/0090722, WO2009/146753. These systems work well but require a superstructure comprising two rails running along the whole length of each row of solar panels, as described e.g., in WO2004/079775. This involves of course an additional cost, but is also in some cases not practical, in particular when rows of solar panels are disposed on a surface which is not perfectly flat or hindered with obstacles such as on the flat roof of buildings, wherein pipes, steps, cables, and the like are so many obstacles to the good alignment of the panels.

US2010/0206294 discloses a mobile cleaning device comprising a frame provided with cleaning means and mounted on wheels, forming a cart suitable for being displaced on the ground on which the tilted solar panels are installed. By pushing the cart along a row of aligned solar panels, the whole surface of a row can be cleaned. This versatile system has the drawback that it requires that the solar panels be installed on a ground free of obstacles to the course of the cart, such as cables, tubes, steps, gaps, shingles, and the like.

Alternatively, robots able to displace themselves over a surface are often used to clean a surface. US2006/0096050 discloses such a washing robot for cleaning steeply inclined surfaces, such as vertical building surfaces comprising two modules: (a) a housing comprising a liquid application cleaning system connected via a cable to (b) a support component that supports and elevates the washing system. The support system is able to move along the upper edge of a building to displace the washing system horizontally and can displace it vertically by actuating a pulley about which runs the cable connecting the two components. Such system is, however, designed to clean large surfaces and is ill fitted for cleaning a series of adjacent solar panels aligned in a row.

It can be seen from the above review of the prior art that it remains a need for a cleaning system for cleaning rows of various dimensions of aligned solar panels, that allows scrubbing of hard adhering dirt, which is faster than most cleaning robots available to date on the market, which requires no additional superstructure like guiding rails, and which can account for light misalignments of the rows. The present invention provides a solution meeting all the above requirements;

### SUMMARY OF THE INVENTION

The present invention is defined in the appended independent claims. Preferred embodiments are defined in the dependent claims. In particular, the present invention concerns a mobile cleaning device suitable for displacing along, and cleaning a series of adjacent tilted solar panels aligned in a row and requiring therefor no superstructure fixed to said row of solar panels, said device comprising:
A supporting frame defining a cleaning plane, on which are mounted:
Cleaning means suitable for cleaning a surface parallel to the cleaning plane;
Support means for maintaining the supporting frame substantially parallel to the surface to be cleaned during the displacement of the cleaning device along a row of solar panels;
Guiding means for guiding the displacement of the cleaning device along a row of solar panels, wherein the guiding means comprise,
at least two, preferably at least three separate guiding wheels, which are aligned along a straight line parallel to the cleaning plane and adjacent to a first edge of the frame, each guiding wheel being mounted such as to rotate about an axis substantially normal to the cleaning plane and suitable for resting and rolling on the upper edge of the aligned solar panels with the cleaning means in cleaning contact with the surface to be cleaned.

The cleaning means preferably comprise at least one rotating brush or cloth suitable for cleaning a surface parallel to the cleaning plane, and extending preferably over the whole length of the frame such as to span over the whole height of a solar panel. A squeegee can also be provided. The rotating brushes can be mounted such as to rotate about an axis normal to the cleaning plane. In an alternative embodiment, the brushes are mounted such as to rotate about an axis parallel to the cleaning plane, and transverse—preferably normal—to the line formed by the at least two guiding wheels.

To improve the cleaning performance the cleaning device of the present invention preferably comprises sprinkling means for sprinkling a liquid onto the surface of a solar panel which is parallel to the cleaning plane. The sprinkling means are preferably disposed in two rows of sprinklers running transverse to the line formed by the guiding wheels (3A), and on either sides of the washing means. A tank containing a cleaning medium selected from soap, a detergent, an anticalcar agent, or a solvent such as alcohol, to be mixed with the liquid prior to spraying onto the surface of to be cleaned can also be provided on said frame. The sprinkling means can be connected to a source of pressurized liquid, such as water, if available close by, or the device may comprise a mobile source of pressurized liquid, as well as of power, which may be mounted on a lorry. Preferably, the rotation of the cleaning brush or cloth is driven by a hydraulic motor fed by the same source of pressurized water as the sprinklers.

In order to keep the supporting frame at a given distance from the surface of the solar panel to be cleaned during the displacement of the cleaning unit, the cleaning device of the present invention preferably comprises at least one support wheel mounted on the same side of the supporting frame as the cleaning means and suitable for rotating about an axis parallel to the cleaning plane and normal to the line formed by the guiding wheels, such as to allow the displacement of the cleaning device along a row of solar panels with the cleaning means in constant cleaning contact with the surface thereof. The displacement of the cleaning device along a row of solar panels is preferably driven by motorized guiding wheels and/or motorized support wheels. The motorization of the device displacement can be driven by a hydraulic motor—e.g., the same as used for rotating the brushes or clothes—or by an electric motor fed by a source of power, such as a battery, a generator, or the net. Alternatively, the cleaning device can be displaced manually by pushing or pulling it along a row of solar panels.

In order to improve the versatility of the cleaning device to be used for cleaning the solar panels in different solar farms, with panels of different geometries, it is advantageous that the distance of the guiding wheels from the frame can be varied easily. Sometimes, the upper edge of a row of adjacent solar panels is not continuously smooth and may comprise either features jutting out of the line of the row, such as fastening elements and the like, e.g., bolts, or a gap between two panels. To ensure a smooth displacement of the cleaning unit even in such cases, the guiding means may comprise at least three guiding wheels, each mounted on resilient means, such as a helicoidal spring, suitable for reversibly disrupting the alignment of the at least three guiding wheels upon hitting an obstacle such as a jutting feature or a gap.

Since the cleaning device of the present invention is meant to clean the whole exposed surface of the solar panels it can additionally be used for scanning and monitoring said surface. For instance, by mounting an infrared camera on the support structure, temperature gradients on the surface of the solar panels can be identified and located, indicative of a malfunctioning of a cell in case, e.g., of a hot spot.

To facilitate the handling of the cleaning device when transferring it from one cleaned row of solar panels to the next to be cleaned, the cleaning device may further comprise at least one handle for holding and handling the device, and/or at least one transportation wheel assisting to the transportation of the device in the way of a wheel barrow.

In a preferred embodiment, the cleaning device of the present invention further comprises a CPU for controlling one or more of:
the rotational velocity of the at least one brush or cloth,
the velocity and direction of rotation of the at least one motorized guiding and/or support wheel,
safety means triggering the stopping of the motor driving the displacement of the cleaning device in case two of the at least three guiding wheels are unloaded or in case at least one guiding wheel has hit an obstacle it cannot pass over,
the flow rate and composition (e.g., concentration of cleaning medium) of the liquid sprayed onto the surface to be cleaned.

The present invention also concerns a method for cleaning tilted solar panels arranged on at least one row and requiring no superstructure fixed to the row of solar panels, comprising the following steps:
Hanging a cleaning device according to any of the preceding claims on the upper edge of a tilted solar panel, such that the guiding means rest on said upper edge, and such that the support means are in supporting contact with said surface to maintain the frame of the cleaning device in a position such that the cleaning means are in cleaning contact with the surface of said solar panel,
Connecting the device to a source of pressurized liquid;
Activating the cleaning means and displacing the cleaning device along the row of tilted solar panels, letting it be guided by the guiding means (3) following the upper edges of the subsequent solar panels aligned in a row.

The cleaning method preferably further comprises:
spraying liquid onto the surface of a solar panel upstream from the advancing device,
rubbing the wet surface of said solar panel, preferably with rotating brushes or clothes,
spraying a rinsing liquid onto the surface of the rubbed solar panel downstream of the advancing device, and
   optionally removing the rinsing liquid from the surface of the solar panel with a squeegee.

The cleaning device of the present invention is particularly suitable for cleaning solar panels aligned in a row and tilted with respect to the horizontal by an angle α comprised between 5 and 85 deg with respect to the horizontal, preferably by an angle between 10 and 60 deg, more preferably by an angle between 20 and 50 deg.

### BRIEF DESCRIPTION OF THE FIGURES

For a fuller understanding of the nature of the present invention, reference is made to the following detailed description taken in conjunction with the accompanying drawings in which:

FIG. 1: shows a perspective view of a first embodiment of cleaning device according to the present invention, in cleaning position on a tilted solar panel,

FIG. 2; shows a side view of the length of the cleaning device of FIG. 1 resting on a tilted solar panel.

FIG. 3: shows a perspective view of the cleaning device of FIG. 1.

FIG. 4: shows a top view of the cleaning device of FIG. 1.

FIG. 5: shows a side view of the cleaning device of FIG. 1 showing the guiding means.

FIG. 6: shows a side view of the cleaning device of FIG. 1 showing the holding means.

FIG. 7: shows a perspective view of a series of rows of aligned solar panels, with the cleaning device of FIG. 1 in cleaning and displacement position on one row.

FIG. 8: shows a perspective view of a second embodiment of cleaning device according to the present invention, in cleaning position on a tilted solar panel.

FIG. 9: shows a top view of the cleaning device of FIG. 8.

FIG. 10: shows a side view of the cleaning device of FIG. 8 showing the guiding means.

FIG. 11: shows a side view of the cleaning device of FIG. 8 in cleaning position on a row of solar panels.

### DETAILED DESCRIPTION OF THE INVENTION

The present invention concerns a mobile cleaning device particularly suitable for cleaning adjacent solar panels (20) disposed in rows of any length, even if the panels are not perfectly aligned, and requiring no permanent equipment in place nor any particular superstructure, like guiding rails, fixed water supply, fixed power supply, and the like. As illustrated in the Figures, the cleaning device (1) of the present invention comprises:
A supporting frame (2) defining a cleaning plane (2A), on which are mounted:
Cleaning means (4) suitable for cleaning a surface parallel to the cleaning plane (2A);
Support means (9) for maintaining the supporting frame (2) substantially parallel to the surface to be cleaned during the displacement of the cleaning device along a row of solar panels (20);
Guiding means (3) for guiding the displacement of the cleaning device along a row of solar panels (20).

The cleaning device of the present invention is characterized in that the guiding means (3) comprise,

at least two, preferably at least three separate guiding wheels (3A), which are aligned along a straight line parallel to the cleaning plane and adjacent to a first edge of the frame (2), each guiding wheel (3A) being mounted such as to rotate about an axis substantially normal to the cleaning plane (2A) and suitable for resting and rolling on the upper edge of the aligned solar panels (20) with the cleaning means (4) in cleaning contact with the surface to be cleaned.

In the context of the present invention, the term “wheel” is meant to encompass any rotating device allowing the transformation of a rotating movement into a linear movement, such as a rotating wheel, roller, gear, pin, and the like. The cleaning device of the present invention actually hangs on the upper edge of the solar panels, with the guiding wheels (3A) resting on said upper edge. This is possible even at low tilting angles of the solar panels with respect to the horizontal of the order of 5 to 10 degrees, and at high tilting angles of the order of 70 to 85 degrees, but is most secure of course with intermediate tilting angles of the order of 20 to 60 degrees, preferably of 25 to 50 degrees, more preferably of 30-38 degrees.

The unique design of the present cleaning device with the guiding wheels (3A) allowing to profit of the upper edge of the solar panels to smoothly displace the cleaning device along a row of solar panels is greatly advantageous as it permits to make without a superstructure permanently fixed to the solar panel rows, such as guiding rails or support bars, as often used in automatic cleaning devices in the art, and which cost is quite high. It also allows the smooth displacement of the cleaning device regardless of the topography of the ground on which the rows of panels are located, such as steps, shingles, cables, pipes, stones, and the like.

In the embodiment wherein the guiding means (3) comprise at least three guiding wheels (3), there are always two wheels in contact with one or two solar panels during passage from one solar panel to the next one in the row, which ensures the stability of the device at any time. This system accounts for small defects in the alignment of the solar panels, which may often occur when the panels are disposed on an area not specifically designed for the purpose, such as a flat roof of a building, loaded with conduits, cables, and the like. The guiding wheels (3A), may each advantageously be mounted on resilient means, such as a helicoidal spring, suitable for reversibly disrupting the alignment of the at least three guiding wheels upon hitting an obstacle such as a bolt jutting out of the top edge of the solar panel row.

To enhance the stability of the cleaning device in operation, it is preferred that the outer edge of the at least three wheels (3A) is profiled to match the geometry of the upper edge of a solar panel. This reduces any risk of slippage of the device off a panel. In case the guiding wheels (3A) are motorized, they may be connected to one another by a flexible sling to form a caterpillar. Such caterpillar allows the device to account for greater defects in the alignment of the solar panels in a row. The caterpillar is preferably profiled such as to reduce any risk of slippage off a panel.

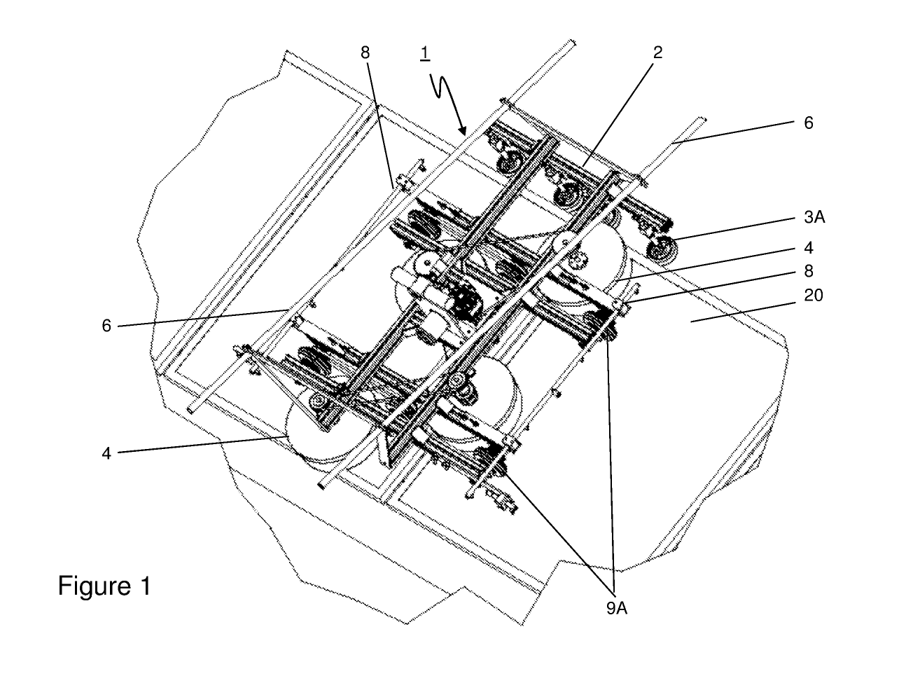

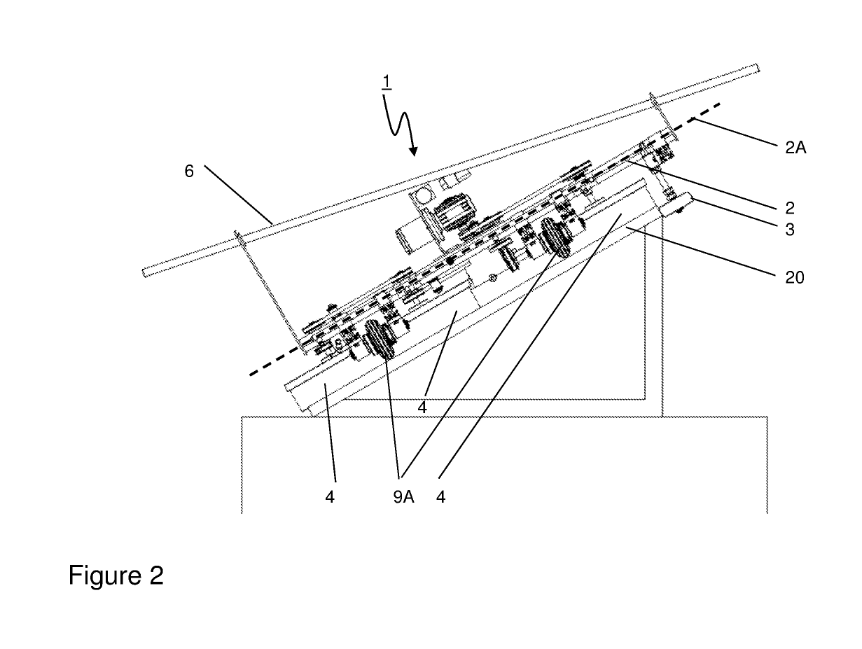

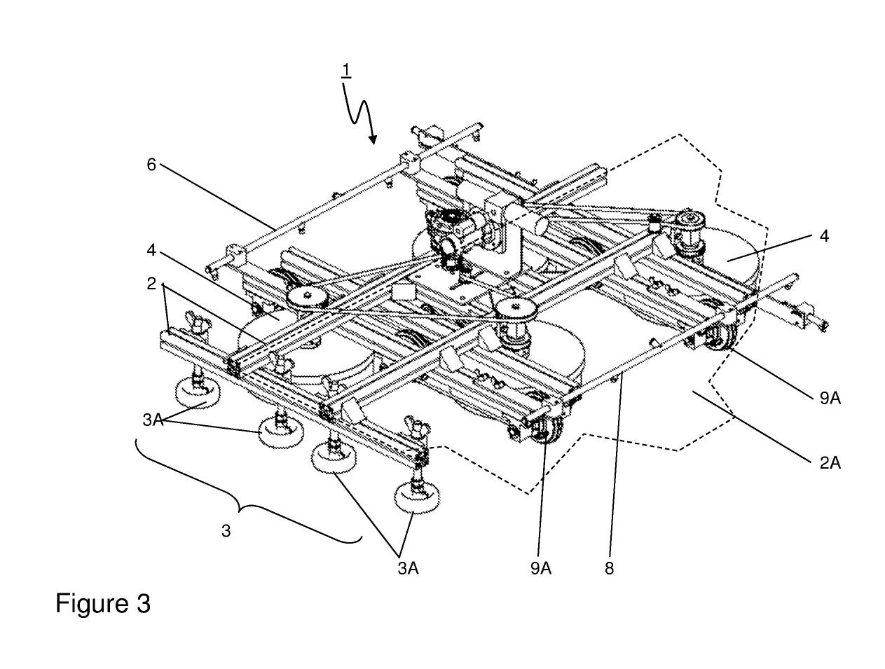

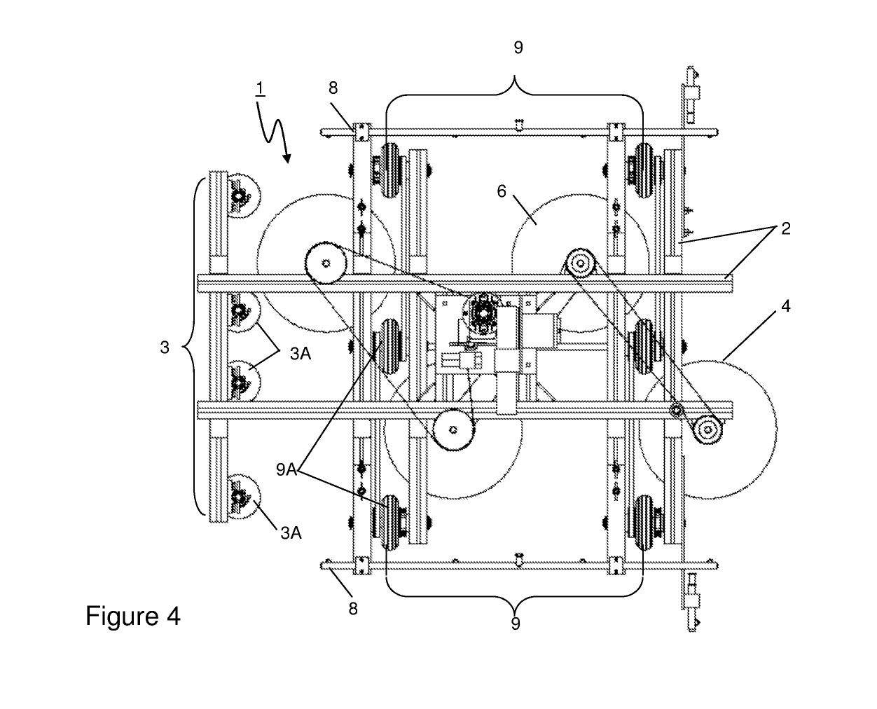

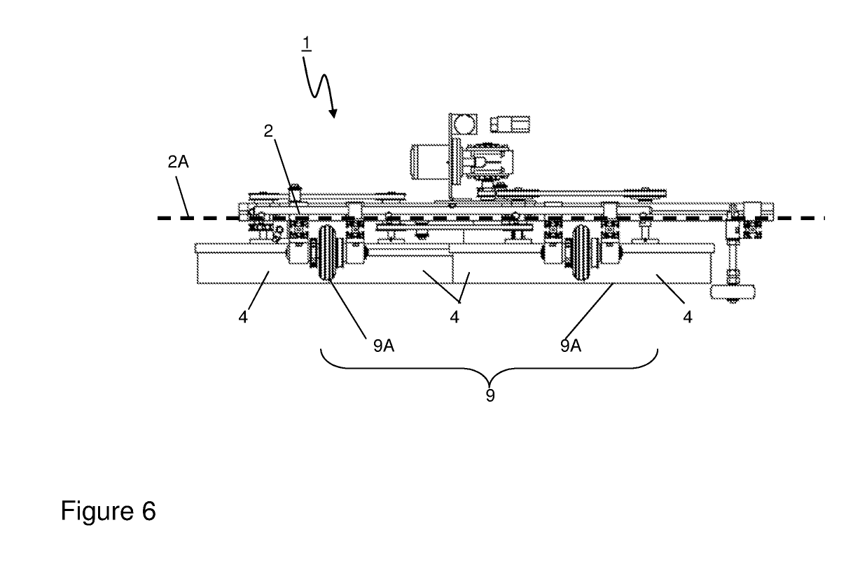

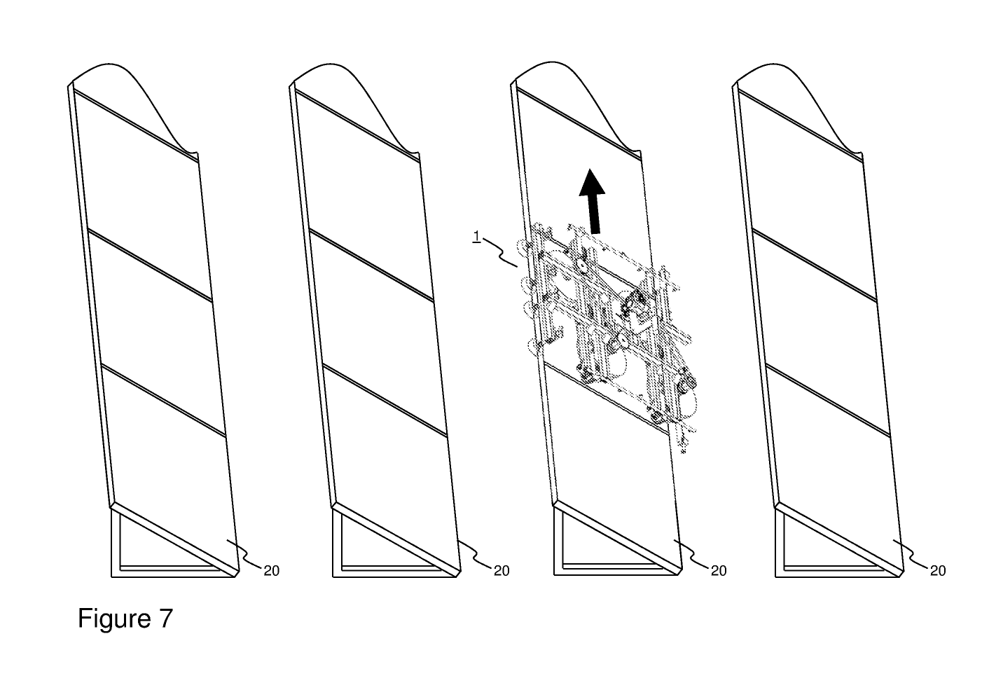

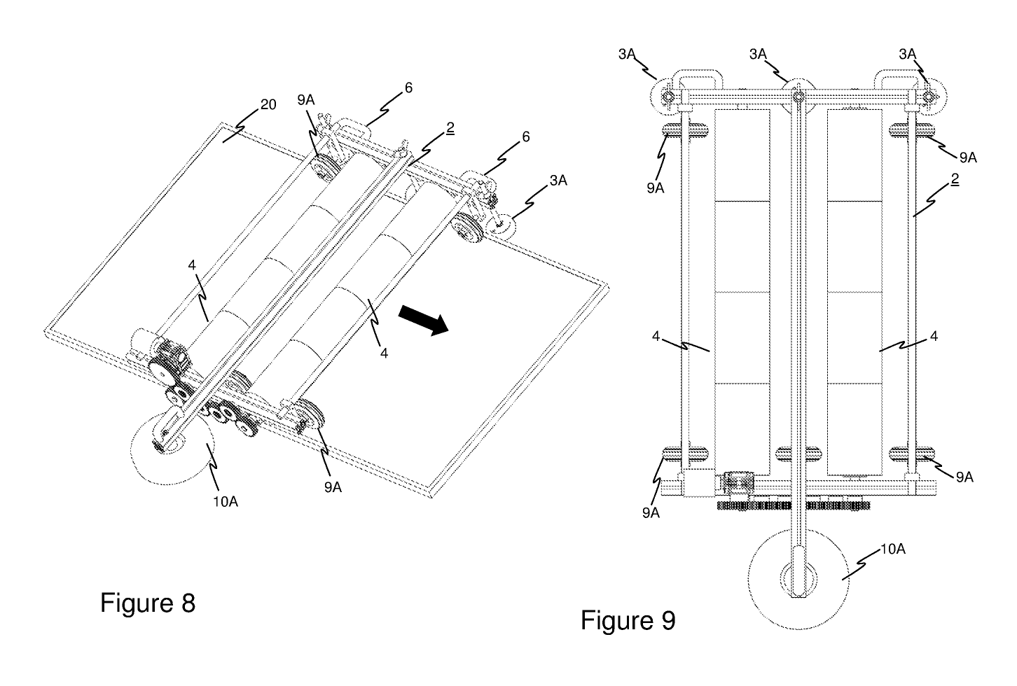

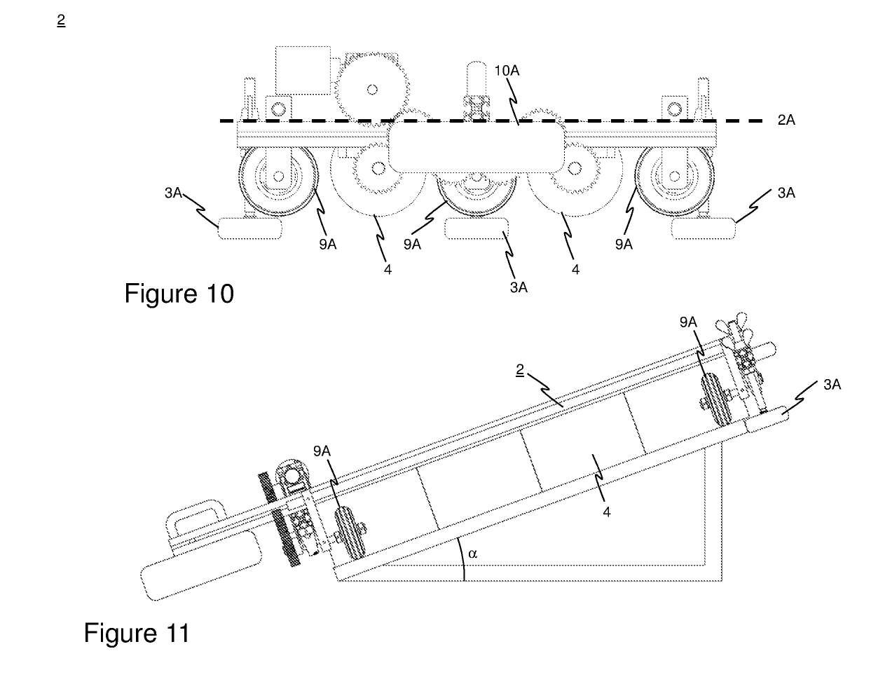

The cleaning means (4) may comprise any means known in the art for cleaning a flat glass surface. They may include a tank mounted on the frame and containing a cleaning medium such as soap, a detergent, an anticalcar agent, a solvent such as alcohol. For example, the cleaning means may comprise blasting means of a particulate matter suitable for cleaning the surface of a solar panel, but it preferably comprises brushes, clothes, and the like, more preferably rotating brushes and/or clothes suitable for sweeping the surface of the solar panels at high velocity as illustrated in the Figures. The brushes or clothes can be mounted to rotate about an axis normal to the cleaning plane (2A) as illustrated in the embodiment represented in FIGS. 1 to 7. Alternatively, they can be mounted such as to rotate about an axis parallel to the cleaning surface (2A) and transverse, preferably normal, to the straight line formed by the guiding wheels (3A) as illustrated in the embodiment of FIGS. 8 to 11. The latter embodiment is advantageous because less brushes are needed since one brush can span the whole height of a solar panel. With less brushes, the driving of the rotation thereof is simplified and the device becomes lighter and easier to displace, either manually or driven by driving wheels, which can be the guiding wheels (3A) or the support wheels (9A) coupled to a motor. The rotation of the brushes or clothes, and optionally of the driving wheels, is preferably driven by a hydraulic motor fed by a source of pressurized water, which can also be used for feeding sprinklers, if any. This embodiment is highly advantageous, as the cleaning device can thus function without a source of power, which is paradoxically not always readily available close to solar panels. A hydraulic motor is also considerably cheaper and lighter than an electrical motor, which facilitates the displacement of the cleaning device.

The brushes or clothes may work in dry conditions to remove principally dust from the surface of the panels, but it is preferred to work in wet conditions. In the latter case, a squeegee in replacement of, or in addition to the brushes and/or clothes, may help to remove the cleaning liquid. Working in wet conditions can be done by providing the cleaning device with sprinkling means (8), oriented to spray a liquid onto the surface of the panels. Since the cleaning device (1) of the present invention should ideally work equally well when running along a row of solar panels from left to right, as from right to left, it should preferably comprise brushes and/or clothes disposed in the middle section of the structure spanning the whole length of the structure (2), which should optimally cover the whole height of a panel, with sprinkling means (8) and squeegees disposed on either sides of the brushes. This way, an array of tilted solar panels arranged in a series of subsequent rows can be cleaned by running a device of the present invention in one direction for the first, third, and all subsequent odd rows, and in the opposite direction for the second, fourth, and all subsequent even rows, thus defining a cleaning circuit forming a serpentine. The circuit is not continuous, since at the end of each row, the device must be withdrawn from the last solar panel of the row which has just been washed and mounted on the first panel of the next row to be washed, which is generally standing directly in front or behind the last panel washed. To facilitate handling of the device, at least one handle (6) may be fixed to the frame (2) for holding and handling the device (1). It is preferably fixed to the upper side of the supporting frame (2) corresponding to the side where the guiding means (3) are located, but extending in the opposite direction with respect to the cleaning plane (2A). It may be advantageous for cleaning devices of larger dimensions to provide a second handle (6) at the bottom of the supporting frame (i.e., side opposite the one comprising the guiding means (3)). At least one transportation wheel (10A) to help transporting the cleaning device from one row of solar panels to the next. A single transportation wheel (10A) as illustrated in FIGS. 8 to 11 can be used as a wheel barrow to easily move around the device by a single person.

In order to maintain the supporting structure (2) of the device at a distance from the surface of the solar panels to be cleaned and thus to avoid scratching thereof, and for facilitating the displacement of the cleaning device along a row of solar panels, the cleaning device of the present invention may comprise at least one support wheel (9a), preferably at least two support wheels (9A), more preferably at least three non aligned support wheels (9A) mounted on the same side of the supporting frame (2) as the cleaning means (4) and each support wheel (9A) being suitable for rotating about an axis parallel to the cleaning plane (2A) and normal to the line formed by the driving wheels (3A) to support the frame at a given distance from a solar panel it rests upon, such that the cleaning means (4) are in cleaning contact with the surface thereof. The orientation of the support wheels (9A) is such that they follow the lateral displacement of the cleaning device along a row of solar panels. Using support wheels (9A) has the advantage of keeping the cleaning means (4) in optimal cleaning contact with the surface of the solar panels, and of avoiding any scratching of the surface. At least three non aligned support wheels (9A) ensure the stability of the supporting frame (2), but it is clear that more support wheels (9A) can also be used as illustrated in the Figures, provided they are well aligned on a plane. The outer edge of the support wheels preferably comprises a soft material, such as a rubber or a polyolefin (e.g., PE, PP), POM, PTFE and the like, to preserve the integrity of the surface of the solar panels. The axis of rotation of the support wheels (9A) may be fixed with an orientation normal to the line defined by guiding wheels (3A), or may be allowed to freely rotate around an axis normal to the cleaning plane. In case the support wheels (9A) are idle, the latter solution is preferred, but in case the support wheels (9A) are motorized, it is preferred to keep their orientation fixed, to prevent any inadvertent jump of the device off course. In order to accommodate solar panels having frames of different thicknesses and depths, it is advantageous to provide the cleaning device of the present invention with means for easily varying the distance of the guiding wheels (3A) from the frame (2). Indeed, when the supporting frame (2) is maintained at an optimal constant distance from the surface of a solar panel by the support wheels (9A), the guiding wheels (3A) must fit exactly to match the top edge of the solar panel frame. Depending on the model of solar panels to be washed, the design of the frame may vary substantially in thickness, in depth, it could be in recess or, on the contrary, overhanging over the surface of the solar panel to protect it from direct dripping, and so on. For this reason, each guiding wheel (3A) is preferably mounted at one end of a rod extending normal to the cleaning plane (2A) and mounted such as to allow the variation of the distance of said rod end from the cleaning plane (2A). For example, a threaded rod engaging in a matching threaded orifice can be used. Alternatively, a smooth rod is engaged in an orifice provided with means for alternatively holding tight the rod into position or letting it run loosely. Any other means known in the art for varying the distance of a wheel from a support structure can be implemented in the device of the present invention, such as pins or a gear.

The displacement of the cleaning device (1) of the present invention may be driven by hand. In this simple, cheaper and lighter embodiment, the operator either pushes or pulls the cleaning device along a row of solar panels until it reaches the end thereof, at which point it carries the cleaning device to the next row to be cleaned. An embodiment of cleaning device to be displaced manually is illustrated in FIGS. 8 to 11, wherein all the guiding and hiding wheels (3A, 9A) are idle. In the absence of driving means, a cleaning device as illustrated in FIGS. 8 to 11 can be as light as 25 to 40 kg, even between 30 and 35 kg, which is easily manageable by a single operator. In an alternative embodiment, the displacement of the cleaning device may be driven by a motor, preferably but not necessarily, the same motor that drives the rotation of the cleaning means (4). This motor may be an electric motor, but it is preferably a hydraulic motor fed by a source of pressurized water, preferably used also for feeding sprinklers. The motor may be coupled to at least one support wheel (9A) or to at least one guiding wheel (3A), to drive the displacement of the device, which allows the cleaning to be performed automatically. The embodiment illustrated in FIGS. 1 to 7 comprises six motorized support wheels (9A) and three idle wheels (3A). As discussed above, in case the guiding wheels (3A) are motorized, it may be advantageous to connect them with a caterpillar. It is preferred that the velocity of the driving means can be controlled independently from the rotational velocity of the cleaning means (4). This can be done by driving them by two separate motors, which is easy to control, but also more expensive and heavier to handle. Alternatively, a single motor may be used to drive both the cleaning means (4) and the driving means (9) with a gear box allowing separate control of their respective velocities.

It is preferred that the guiding means (3) comprise at least three guiding wheels (3A) so that at least two of the at least three guiding wheels (3A) are always in contact with the upper edge of the solar panels even when passing over a gap between one panel and the neighbouring panel. A device of the present invention comprising at least three guiding wheels (3A) preferably comprises safety means controlled by a CPU mounted on the frame of the cleaning device and programmed to trigger the stopping of the motor driving the motion of the cleaning device (1) in case two of the at least three guiding wheels (3A) are unloaded. As discussed above, in use two of the at least three guiding wheels (3) are permanently in contact with the edge of one or two solar panels, and support the whole weight of the cleaning device resting on the tilted surface of a solar panel. When the cleaning device reaches the end of a row, or if two panels in a row are too distant from one another, or misaligned to a point that the cleaning device cannot ensure a continuous path, the cleaning device may end up holding to the upper edge of a solar panel by a single guiding wheel (3A), the other two being unloaded in contact with no solid structure. In this case, the safety feature would immediately stop the motion of the cleaning device to prevent it from falling to the ground. In case the device comprises more than three wheels, the safety device may be programmed for stopping the motor when a given number of guiding wheels are unloaded. The safety feature may also be programmed to activate the driving motor in a reverse direction to attempt to re-establish the contact of the last unloaded wheel with the upper edge of a solar panel.

The CPU can also be programmed to control other features such as.
the rotational velocity of the at least one brush or cloth (4),
the velocity and direction of rotation of the at least one motorized guiding and/or support wheel (3A, 9A),
safety means triggering the stopping of the motor driving the displacement of the cleaning device (1) in the event at least one guiding wheel (3A) hits an obstacle it cannot pass over,
the flow rate and composition of the liquid sprayed onto the surface to be cleaned,
a camera, preferably an IR camera, for scanning the surface of the solar panels to identify anomalies.

Indeed, since the cleaning device of the present invention is meant to clean the whole exposed surface of the solar panels it can additionally be used for scanning and monitoring said surface. An infrared camera could for instance be used to identify hot spots indicative a malfunctioning solar cell. Other monitoring instruments can be mounted to measure different parameters, such as electromagnetic fields, rugosity, and the like.

The cleaning device of the present invention can advantageously be used in a method for cleaning tilted solar panels arranged on at least one row, comprising the following steps:
Hanging a cleaning device (1) according to any of the preceding claims on the upper edge of a tilted solar panel (20), such that the guiding means (3) rest on said upper edge, and such that the support means (9) are in supporting contact with said surface to maintain the frame (2) of the cleaning device in a position such that the cleaning means (4) are in cleaning contact with the surface of said solar panel,
Connecting the device (1) to a source of pressurized liquid;
   Activating the cleaning means (4) and displacing the cleaning device along the row of tilted solar panels, letting it be guided by the guiding means (3) following the upper edges of the subsequent solar panels (20) aligned in a row.

To enhance the cleaning performance of the present cleaning device, it is preferred to include the additional following steps:
spray liquid onto the surface of a solar panel upstream from the advancing device (1),
rub and wipe the soaped surface of said solar panel, preferably with rotating brushes or clothes,
optionally spray a rinsing liquid onto the surface of the rubbed solar panel downstream of the advancing device (1), and
optionally remove the rinsing liquid from the surface of the solar panel with a squeegee or a curtain of pressurized gas.

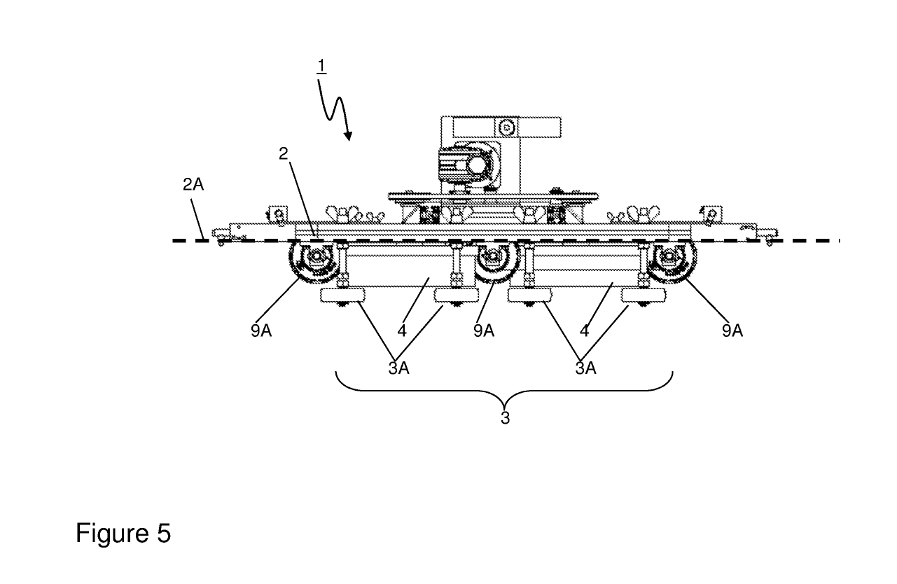

As discussed above, cleaning of the solar panels in wet conditions may be achieved by providing the cleaning device with sprinkling means (8) for sprinkling a liquid, such as soaped water and/or clear water, onto a surface parallel to the cleaning surface, said sprinkling means (8) being preferably disposed in two rows of sprinklers running parallel to the length of the device, and on either sides of the washing means (4), so as to allow the use of the cleaning device in both directions of motion along a row of solar panels. Such embodiment is well illustrated in FIG. 5.

Paradoxically, although solar panels produce power, a source of power is not always readily available in the vicinity of the solar panels to power the cleaning device. Similarly, a source of pressurized liquid is not always available for wet cleaning applications. To solve this problem, it may be advantageous to provide a mobile source of power and/or a mobile source of pressurized liquid to permit the automatic cleaning of solar panels even in places devoid of any source of power or liquid. The mobile sources of power and pressurized liquid may be loaded on a lorry and connected to the cleaning device by a cable for the power and by hoses for the liquid. The cables and hoses may be of considerable length in cases such as when solar panels are arranged on top of a building of considerable height, or when they are arranged in rows of considerable length.

1. A mobile cleaning device suitable for displacing along, and cleaning a series of adjacent tilted solar panels aligned in a row and requiring therefor no superstructure fixed to said row of solar panels, said device comprising:
a supporting frame defining a cleaning plane, on which are mounted:
a cleaning device suitable for cleaning a surface parallel to the cleaning plane;
a support device for maintaining the supporting frame substantially parallel to the surface to be cleaned during the displacement of the cleaning device along a row of solar panels; and
a guiding device for guiding the displacement of the cleaning device along a row of solar panels,
wherein the guiding device comprises,
at least two, preferably at least three separate guiding wheels, which are aligned along a straight line parallel to the cleaning plane and adjacent to a first edge of the frame, each guiding wheel being mounted such as to rotate about an axis substantially normal to the cleaning plane and suitable for resting and rolling on the upper edge of the aligned solar panels with the cleaning device in cleaning contact with the surface to be cleaned.

2. The cleaning device according to claim 1, wherein the outer edge of the guiding wheels is profiled to match the geometry of the upper edge of a solar panel.

3. The cleaning device according to claim 2, wherein the cleaning device comprises at least one brush or cloth which is motorized to rotate about an axis normal or parallel to the cleaning plane, preferably to rotate about an axis parallel to the cleaning plane and transverse, more preferably normal, to the straight line formed by the guiding wheels, wherein the cleaning device preferably extends over the whole length of the frame such as to span over the whole height of at least one solar panel, and more preferably the cleaning device further comprises at least one squeegee.

4. The cleaning device according to claim 3, further comprising a sprinkling device for sprinkling a liquid onto a surface parallel to the cleaning plane, said sprinkling device being preferably disposed in two rows of sprinklers running transverse to the line formed by the guiding wheels, and on either sides of the washing device, and said cleaning device preferably further comprising a tank containing a cleaning medium selected from soap, a detergent, an anticalcar agent, or a solvent such as alcohol, to be mixed with the liquid prior to spraying onto the surface to be cleaned.

5. The cleaning device according to claim 4, wherein the support device comprises at least one support wheel mounted on the same side of the supporting frame as the cleaning device and suitable for rotating about an axis parallel to the cleaning plane and normal to the line formed by the guiding wheels to support the frame at a given distance from a solar panel it rests upon during the displacement of the cleaning device, such that the cleaning device is in cleaning contact with the surface thereof.

6. The cleaning device according to claim 5, wherein at least one guiding wheel, and/or at least one support wheel is motorized to drive the displacement of the cleaning device along a row of solar panels.

7. The cleaning device according to claim 6, further comprising a CPU for controlling one or more of:
the rotational velocity of the at least one brush or cloth,
the velocity and direction of rotation of the at least one motorized guiding and/or support wheel,
a safety device triggering the stopping of the motor driving the displacement of the cleaning device in case two of the at least three guiding wheels are unloaded or in case at least one guiding wheel has hit an obstacle it cannot pass over, and
the flow rate and composition of the liquid sprayed onto the surface to be cleaned.

8. The cleaning device according to claim 7, wherein the distance of the guiding wheels from the frame can be varied easily.

9. The cleaning device according to claim 8, wherein the guiding device comprises at least three guiding wheels, each mounted on a resilient substance, suitable for reversibly disrupting the alignment of the at least three guiding wheels upon hitting an obstacle.

10. The cleaning device according to claim 9, further comprising mounted on the frame:
a camera, preferably an IR camera, and/or
at least one handle for holding and handling the device, and/or
at least one transportation wheel for assisting the transfer of the cleaning device from one cleaned row to a next row of solar panels to be cleaned.

11. The cleaning device according to claim 10, being further connected to a mobile source of pressurized liquid, and/or a mobile source of power, either or both being preferably mounted on a lorry.

12. The cleaning device according to claim 11, wherein the motor driving the rotation of the at least one brush or cloth and, optionally, driving the displacement of the cleaning device, is a hydraulic motor activated by pressurized water fed from the same source as the water sprayed onto the surface to be cleaned.

13. A method for cleaning tilted solar panels arranged on at least one row and requiring no superstructure fixed to the row of solar panels, comprising:
hanging a cleaning device according to claim 1 on the upper edge of a tilted solar panel, such that the guiding device rests on said upper edge, and such that the support device is in supporting contact with said surface to maintain the frame of the cleaning device in a position such that the cleaning device is in cleaning contact with the surface of said solar panel,
connecting the device to a source of pressurized liquid;
activating the cleaning device and displacing the cleaning device along the row of tilted solar panels, letting the cleaning device be guided by the guiding device following the upper edges of the subsequent solar panels aligned in a row.

14. The method according to claim 13 further comprising:
spraying a liquid onto the surface of a solar panel upstream from the advancing device,
rubbing the wet surface of said solar panel, preferably with rotating brushes or clothes,
optionally spraying a rinsing liquid onto the surface of the rubbed solar panel downstream of the advancing device, and
optionally removing the rinsing liquid from the surface of the solar panel with a squeegee or a curtain of pressurized gas.

15. The method according to claim 14, wherein the solar panels aligned along at least one row are tilted by an angle, α, comprised between 5 and 85 degrees with respect to the horizontal, preferably by an angle between 10 and 60 degrees, more preferably by an angle between 20 and 50 degrees.

16. The cleaning device according to claim 1, wherein the cleaning device comprises at least one brush or cloth which is motorized to rotate about an axis normal or parallel to the cleaning plane, preferably to rotate about an axis parallel to the cleaning plane and transverse, more preferably normal, to the straight line formed by the guiding wheels, wherein the cleaning device preferably extends over the whole length of the frame such as to span over the whole height of at least one solar panel, and more preferably the cleaning device further comprises at least one squeegee.

17. The cleaning device according to claim 1, further comprising a sprinkling device for sprinkling a liquid onto a surface parallel to the cleaning plane, said sprinkling device being preferably disposed in two rows of sprinklers running transverse to the line formed by the guiding wheels, and on either sides of the washing device, and said cleaning device preferably further comprising a tank containing a cleaning medium selected from soap, a detergent, an anticalcar agent, or a solvent such as alcohol, to be mixed with the liquid prior to spraying onto the surface to be cleaned.

18. The cleaning device according to claim 16, further comprising a CPU for controlling one or more of:
the rotational velocity of the at least one brush or cloth,
the velocity and direction of rotation of the at least one motorized guiding and/or support wheel,
a safety device triggering the stopping of the motor driving the displacement of the cleaning device in case two of the at least three guiding wheels are unloaded or in case at least one guiding wheel has hit an obstacle it cannot pass over, and
the flow rate and composition of the liquid sprayed onto the surface to be cleaned.

19. The cleaning device according to claim 16, wherein the motor driving the rotation of the at least one brush or cloth and, optionally, driving the displacement of the cleaning device, is a hydraulic motor activated by pressurized water fed from the same source as the water sprayed onto the surface to be cleaned.

20. The cleaning device according to claim 1, further comprising mounted on the frame:
a camera, preferably an IR camera, and/or
at least one handle for holding and handling the device, and/or
at least one transportation wheel for assisting the transfer of the cleaning device from one cleaned row to a next row of solar panels to be cleaned.
